(19) United States
(12) Patent Application Publication
(10) Pub. No.: US 2025/0230567 A1
(43) Pub. Date: Jul. 17, 2025

(54) PRE-BRAZE ELECTROLYTIC NICKEL PLATING ONTO COPPER FOR HEAT EXCHANGERS

(71) Applicant: Dana Canada Corporation, Oakville (CA)

(72) Inventors: Mohammad Mehdi JALILI, Oakville (CA); Mohammad Hadi RAZMPOOSH, Mississauga (CA)

(21) Appl. No.: 18/412,937

(22) Filed: Jan. 15, 2024

(51) Int. Cl. C25D 5/48; C25D 3/12; C25D 5/34

(52) U.S. Cl. CPC C25D 5/48; C25D 5/34; C25D 7/0614; F28F 19/06; F28F 21/085; F28F 2275/04

(57) ABSTRACT

Systems and methods are provided for pre-braze plated heat exchangers. A method of forming a heat exchanger is described, including pretreating one or more copper pieces including blanks and coils, electrolytically plating nickel onto the one or more copper pieces, stamping components of a heat exchanger from the one or more nickel plated copper pieces; and brazing stamped nickel plated components of the heat exchanger.

### TECHNICAL FIELD

The present description relates generally to a method of coating copper heat exchanger parts with nickel prior to brazing.

### BACKGROUND AND SUMMARY

Heat exchangers for cooling electronics in vehicles, especially electric and hybrid vehicles, can be made of copper or aluminum parts which are brazed to join the parts together. Copper and aluminum both have advantages and disadvantages which lead to one being more appropriate depending on the application. For example, an advantage of copper is its higher thermal conductivity, meaning heat exchangers made of copper are able to transfer heat away from electrical components more efficiently than heat exchangers made of aluminum. However, aluminum heat exchangers may be preferred when heat transfer requirements are lower, due to the relatively lower cost and weight of aluminum compared to copper. Therefore, using a copper brazed heat exchanger (CBHE) in combination with an aluminum brazed heat exchanger (ABHE) within a system may be desired. For example, an ABHE may be used to cool a traction battery, while a CBHE may be used to cool an electrical inverter, with a common coolant fluid in contact with both heat exchangers. When used together, galvanic reactions may take place between CBHEs and ABHEs through the coolant acting as an electrolyte, thereby degrading the copper. There are also other conditions in which copper heat exchangers are degraded.

To provide corrosion protection and delay coolant degradation, CBHEs are often plated, for example with nickel. In current production methods, a coating of nickel is applied after brazing, or assembling components together, often through an electroless plating method. Electroless nickel plating uses a chemical reducing agent in solution and allows for deposition of nickel ions onto internal surfaces of copper heat exchanger shapes such as flow passages where electrolytic plating would not be adequate.

However, there are several drawbacks to post-braze electroless nickel plating. One such disadvantage is that the electroless nickel plating process imposes design restrictions on CBHEs that demand a balance of heat exchanger effectiveness and plating quality (e.g. even and accurate thickness). For example, because electroless plating relies on solution flow to evenly deposit nickel ions on a copper surface, the geometry and size of inner flow passages may be limited (e.g., in diameter and/or length) in order to maintain sufficient flow of the plating solution. Thus, while electroless plating is more effective for post-braze plating than electrolytic plating, electroless plating still restricts the effectiveness of heat exchangers. Another drawback of post-braze plating is that braze joints may be damaged in a pretreatment process preceding nickel plating, compromising the structural integrity and performance of CBHEs which are post-braze nickel plated. Further, post-braze plating may lead to impurities, such as metallic particles, being present in a heat exchanger formed by post braze plating. As cleanliness (e.g., lack of impurities) of heat exchangers is a factor in proper function of heat exchangers in many applications, including thermal regulation of electronics, heat exchangers with impurities due to post-braze plating may not meet standards for adequate performance.

In one embodiment, the issues described above may be at least partially addressed by plating copper with nickel, and forming the nickel plated copper into nickel plated copper components prior to brazing the nickel plated copper components of a heat exchanger. In some embodiments, a copper blank may be pretreated before being plated with nickel, then stamped into components. Next, the components may be assembled and brazed to form a CBHE. In other embodiments, other starting forms of copper or copper alloy may be used than a copper blank. In this way, a variety of forms of CBHEs may be achieved by incorporating pre-braze nickel plating. In addition, plating prior to brazing removes design restrictions, for example on flow passages, and allows for heat exchangers to be further optimized, so long as plating thickness is within a certain range for demanded brazing strength. Pre-braze plating may also increase the consistency of plating thickness throughout a heat exchanger, compared to post-braze plating where ions are deposited on irregular surfaces such as sharp corners. Further, pre-braze plating may reduce degradation of braze joints during pretreatment and may reduce a resource demand of plating compared to post-braze plating. Moreover, pre-braze plating may reduce impurities, leading to a higher cleanliness level than achievable by post-braze plating. The differences in nickel diffusion and plating structure between pre-braze plated and post-braze plated heat exchangers can be identified by studying the material through metallurgical examination techniques. Finally, the cost of manufacturing a heat exchanger through pre-braze electrolytic plating may be lower than the cost associated with post-braze electroless plating.

There are also associated advantages of pre-braze plating allowing for electrolytic plating rather than electroless plating. For example, electrolytic plating can be performed using pure nickel, while electroless plating uses phosphorus in addition to nickel. Consequently, electrolytic plating may result in plated materials with higher conductivity and lower heat resistance, leading to better performance and durability of CBHEs plated with this method.

For all of the reasons given above, pre-braze electrolytic nickel plating may be an advantageous method over the current technology of post-braze electroless nickel plating for creating CBHEs for cooling vehicle electronics, as well as a variety of other uses of heat exchangers. Additionally, pre-braze nickel plating onto copper may be desired in forming assemblies of nickel plated copper components for other applications than heat transfer.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a flowchart of a method for pre-braze nickel plating onto copper that may be used to form a CBHE.

FIG. 2 shows an example embodiment of a copper blank at steps of a pre-braze nickel plating method.

FIG. 3 shows an example embodiment of a copper coil at steps of a pre-braze nickel plating method.

FIG. 4 shows a continuous production line for creating CBHEs with pre-braze nickel plating.

FIG. 5 shows a cross section of an example braze joint of a CBHE that was plated pre-braze.

FIG. 6 shows an example embodiment of a CBHE.

FIG. 7A shows an example metallurgical examination image of a heat exchanger formed by a post-braze nickel plating process.

FIG. 7B shows an example metallurgical examination image of a heat exchanger formed by a pre-braze nickel plating process, such as the method of FIG. 1.

### DETAILED DESCRIPTION

The following disclosure relates to a method of creating heat exchangers, or other nickel plated copper assemblies, with pre-braze nickel plating onto copper. The method may include pretreatment, electrolytic plating, stamping, assembly, and brazing. Compared to post-braze nickel plating onto copper, pre-braze nickel plating may reduce design restrictions, lower manufacturing resource demand, eliminate degradation of braze joints during pretreatment of a post-braze plating process, and allow for a more even thickness of plating. As used herein, “copper” may refer to pure copper and/or copper alloy material, and similarly, “nickel” may refer to pure nickel metal and/or nickel alloy material.

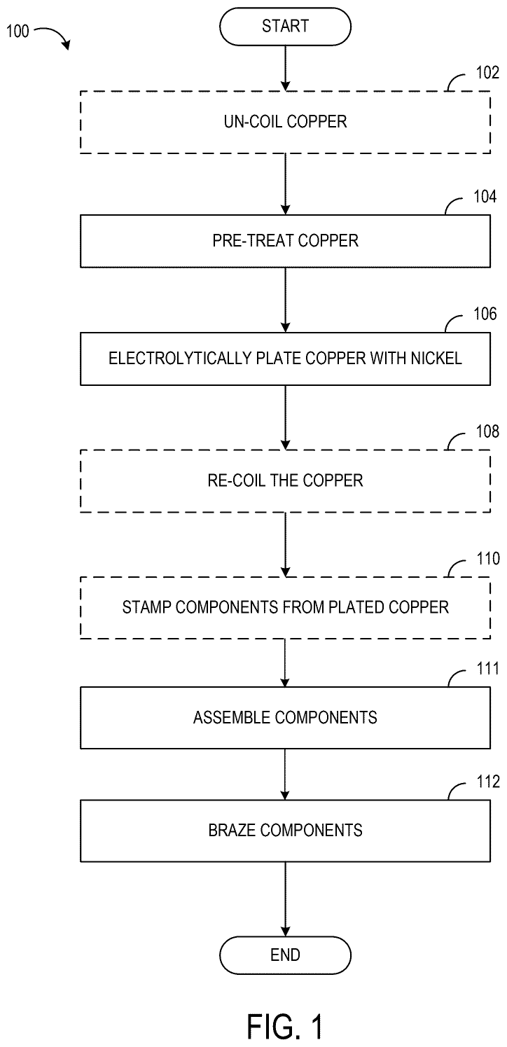

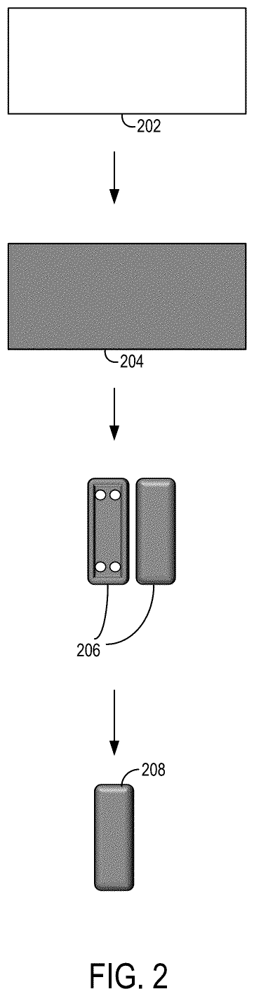

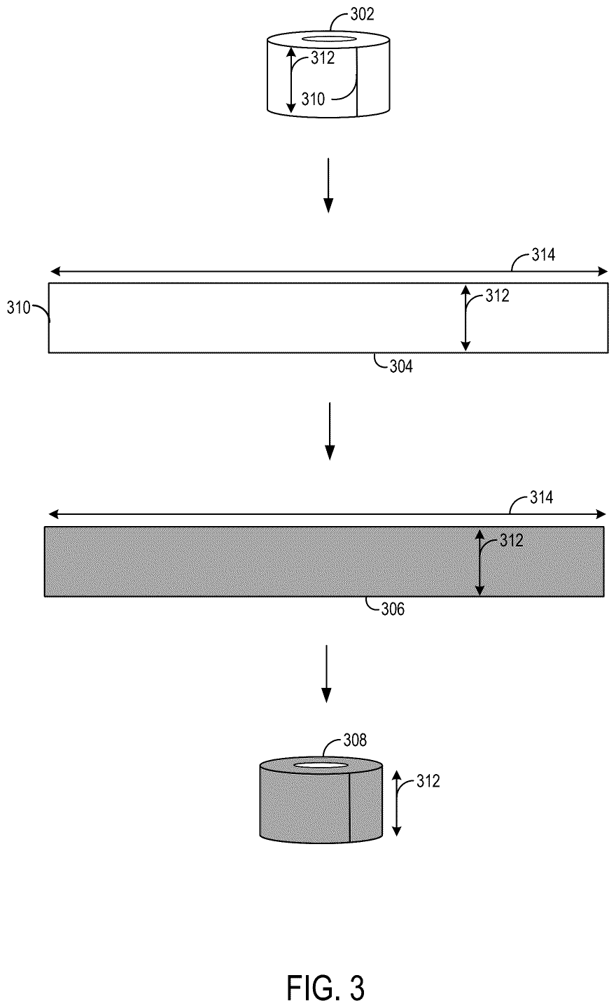

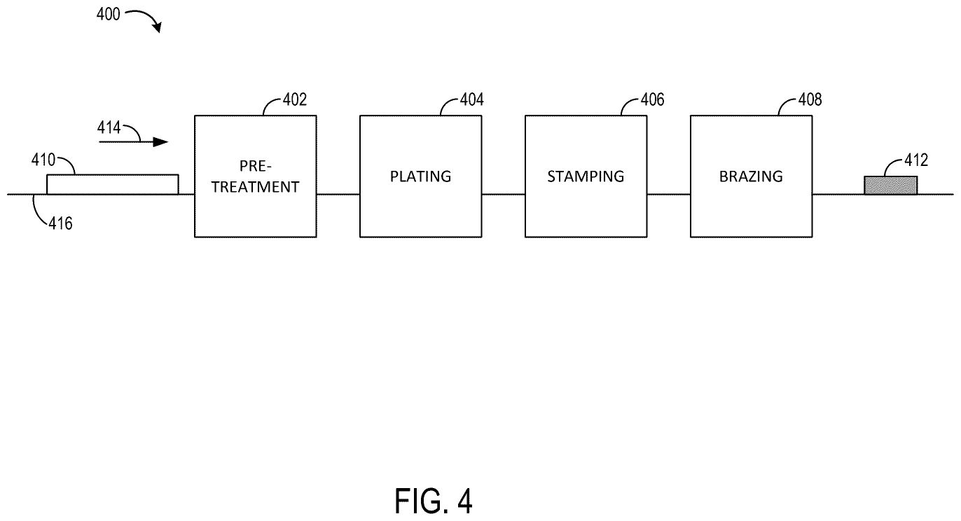

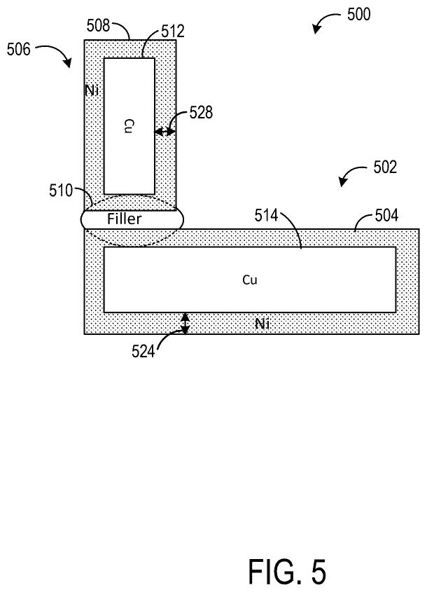

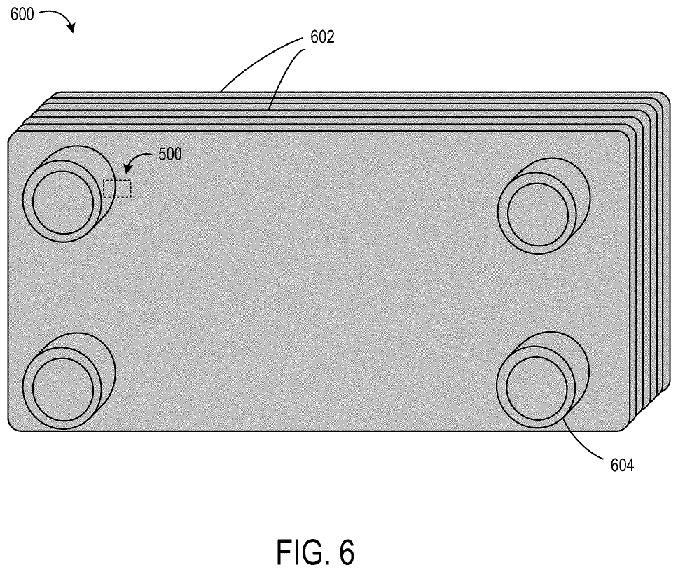

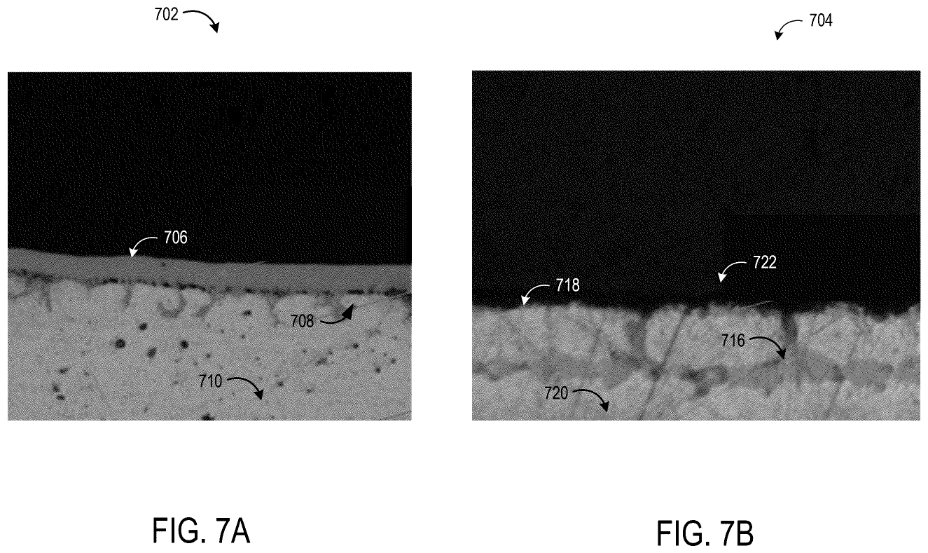

FIG. 1 shows a method of pre-braze nickel plating unformed copper pieces (e.g., copper coil or copper blank) and/or copper components, which may form a CBHE. As indicated above, the copper pieces and/or copper components may be pure copper and/or copper alloys. FIGS. 2 and 3 show examples of materials before and after steps of the method from FIG. 1, starting with a copper blank and copper coil, respectively. FIG. 4 shows an example of an assembly line wherein a continuous process implements the method of FIG. 1 to create nickel plated CBHEs. FIG. 5 shows an example braze joint of a CBHE, such as a CBHE shown in FIG. 6, formed by a pre-braze plating method such as the method of FIG. 1. In FIGS. 2-6, nickel is represented by shading. FIGS. 7A and 7B show example images taken from metallurgical examination of a post-braze plated heat exchanger and a pre-braze plated heat exchanger, respectively, for comparison of resulting structures.

Referencing FIG. 1, a method 100 is shown for pre-braze nickel plating onto copper. For example, method 100 may be used to form a CBHE. In other examples, an assembly may be formed by method 100 from pre-braze nickel plated copper components for other applications than heat transfer. A starting copper piece for method 100 may be an unformed copper piece. For example, the starting unformed copper piece for method 100 may be in the form of a copper coil such as copper coil 302 of FIG. 3. A copper coil suitable for method 100 may be a flat rectangular shaped material (e.g., uncoiled copper coil 304 of FIG. 3) rolled into a coil with cylindrical shape, such that a short end (e.g., end 310) may be accessible on an outside of the coil. The copper coil may include a variety of dimensions, such as lengths (e.g., length 314 of uncoiled copper coil 304 in FIG. 3), widths (e.g., width 312 of copper coil 302 in FIG. 3), thicknesses, and combinations thereof. Additionally or alternatively, the starting unformed copper piece for method 100 may be in the form of a copper blank (e.g., a rectangular prism) such as copper blank 202 of FIG. 2. Similar to copper coils, copper blanks may be of a variety of dimensions depending on sizes of desired CBHE assemblies and available equipment. Additionally or alternatively, the starting copper material may be pre-stamped, rather than unformed copper, such that the copper is in a shape of one or more CBHE components prior to starting method 100. Determining starting copper forms may take into account several factors, including a desired CBHE shape and size, as well as efficiency and cost of manufacturing processes. For example, when forming a CBHE with components including several plates of a certain thickness, a copper blank of a same or similar thickness may be chosen to start method 100. Pre-stamped components may also be chosen in this example, however, the process may be less efficient than starting with a blank, depending on the shapes of the pre-stamped components.

Formation of a CBHE with method 100 may be completed by a continuous assembly line such as assembly line 400 of FIG. 4. In some embodiments, the copper starting piece 410 may take any of the forms described above and may travel along path 416 in a direction designated by arrow 414 to each of a pretreatment unit 402, electrolytic plating unit 404, stamping unit 406, and brazing unit 408, resulting in a nickel plated CBHE 412. The nickel plated CBHE 412 may take several forms, according to the starting materials and resulting stamped components. For example, the nickel plated CBHE 412 may be a brazed plate heat exchanger (e.g., brazed plate heat exchanger 600 of FIG. 6) made of a plurality of nickel plated copper plates, among other components. The assembly line 400 may be an automated process, a series of manually completed steps, or a mixture thereof. Having an assembly line may streamline the production of CBHEs and contribute to higher efficiency. Alternatively, CBHEs may be formed individually through method 100, rather than in a continuous process such as assembly line 400 in FIG. 4.

Returning to FIG. 1, method 100 begins with optionally uncoiling a copper coil at 102. Because the starting copper piece may be a coil and/or a blank and/or a CBHE component, this step may occur when a coil is to be plated. In other words, if the starting copper piece is not a coil, such as a blank and/or pre-stamped components, 102 may not be completed. Uncoiling a copper coil may result in an uncoiled copper coil such as a long, flat, rectangular copper piece (e.g.

uncoiled copper coil 304 of FIG. 3). Uncoiling the copper coil may be achieved by means of an automated and/or manual process as part of a continuous assembly line, such as before or part of the pretreatment unit 402 in assembly line 400 of FIG. 4. In some examples, the copper coil may be rotated into different orientations than shown in FIG. 3 before being uncoiled. An uncoiled copper material may be more suitable for electrolytic nickel plating than a coil due to exposure of copper surface in the uncoiled form.

Method 100 proceeds to 104 wherein the copper is pretreated to ensure adequate quality of the plating. The raw starting copper material may contain impurities such as dirt, oil, grease, oxides, and other extraneous materials which can impede proper plating. Therefore, pretreatment is completed at 104 to remove such materials from the copper surface in order to achieve adequate quality in terms of adhesion and durability of the nickel plating. Pretreatment may include cleaning of the unformed copper starting piece (e.g. copper blank 202 of FIG. 2 and/or copper coil 302 of FIG. 3) with a series of chemical cleaning agents and physical methods (e.g., abrasion and ultrasonic agitation). Cleaning agents used in the pretreatment process may include acid cleaners and chemicals which are surface-active with copper. Other appropriate pretreatment methods may also be used to remove impurities and prepare copper for plating. Pretreatment may occur at a pretreatment unit of a continuous assembly line, such as pretreatment unit 402 of assembly line 400, shown in FIG. 4.

Following 104, method 100 proceeds to 106 to electrolytically plate the pretreated copper. Electrolytic plating may involve putting the pretreated copper material (e.g., copper blank 202 of FIG. 2, uncoiled copper coil 304 of FIG. 3, or a pretreated pre-stamped copper component) and a piece of nickel or nickel alloy into a plating electrolyte solution, and applying continuous electricity such that the copper behaves as a cathode and the nickel behaves as an anode. Thus, nickel ions may be deposited onto the copper such that nickel ions are evenly disposed in a nickel coating of a thickness on surfaces of the copper, wherein the thickness of the nickel coating may be within a range for successful brazing of the CBHE in later steps, as well as pressure durability and corrosion resistance. A lower bound of the thickness range may prevent a nickel plating coating that is too thin which may reduce corrosion protection. An upper bound of the thickness range may ensure that a brazing filler metal may diffuse through the nickel coating for strong braze joints, as will be discussed further. For example, the lower bound of the thickness range may be 0.5 μm and the upper bound of the thickness range may be 5 μm. In other words, the thickness of nickel coating may be greater than or equal to 0.5 μm for sufficient corrosion protection and/or less than or equal to 5 μm to achieve adequately strong braze joints. In another example, the thickness range may be between 1 and 4 μm, 2 and 3 μm, or 1.5 and 2.5 μm to increase corrosion protection for applications with greater exposure to degrading elements (e.g., aluminum with common coolant fluid acting as an electrolyte) and/or higher rate of degradation (e.g., due to changes in pH and/or temperature of coolant fluid acting as an electrolyte), and allow for a desired tolerance in precision of filler diffusion distances. In some examples, the thickness range may be between 0.5 μm and 2 μm, with braze joint strength being greatest in this range. An amount of nickel put in the plating electrolyte solution may be determined (e.g., calculated, estimated) according to scale of equipment and/or size metrics of the CBHE design, including mass and surface area. The nickel may be pure nickel, and a nickel alloy may also be used. The plating electrolyte solution may contain nickel sulphate, and/or another suitable compound. Electrolytic plating may include one or more types of electroplating (e.g., barrel, rack, continuous, line, and the like) and may be part of a continuous assembly line such as electrolytic plating unit 404 of assembly line 400 in FIG. 4. There may be one or more electrolytic plating units (e.g., electrolytic plating unit 404 of FIG. 4). For example, there may be an electrolytic plating unit for each type of copper starting material (e.g., blank, coil). One or more pretreated copper materials may be plated simultaneously in a same plating electrolyte solution with electricity applied to each piece of pretreated copper. Additionally or alternatively, there may be several separate containers of plating electrolyte solution wherein copper may be plated. The result of electrolytic plating at 106 may be a nickel plated copper piece (e.g., a nickel or nickel alloy plated copper or copper alloy piece) resembling nickel plated copper blank 204 of FIG. 2 and/or uncoiled, nickel plated copper coil 306 of FIG. 3, wherein shading indicates a nickel coating. Although method 100 describes electrolytically plating copper with nickel, other plating methods have also been considered. For example, electroless plating may be included in a pre-braze plating method such as method 100, although electroless plating may have a greater resource demand and/or may be less effective than electrolytic plating in a pre-braze plating method.

After electrolytically plating, method 100 proceeds to 108 wherein the nickel or nickel alloy plated copper or copper alloy piece is optionally re-coiled to form a re-coiled, nickel plated copper coil if the starting un-plated copper piece was a copper coil (e.g. copper coil 302 of FIGS. 3) and 102 was completed. In other words, if the starting un-plated copper piece was a blank, pre-stamped component, or other shape besides a coil, 108 may not be completed. For example, uncoiled copper coil 304 of FIG. 3 may be electrolytically plated to form uncoiled, nickel plated copper coil 306 of FIG. 3, and uncoiled, nickel plated copper coil 306 may be re-coiled. The resulting nickel plated coil after re-coiling at 108 may resemble re-coiled, nickel plated copper coil 308 of FIG. 3 where a re-coiled shape may be the same as a shape of the copper coil 302. Alternatively, the re-coiled shape may differ from the starting copper coil shape in at least one of number of rotations, length, width, diameter, and/or other coil dimensions as described with reference to FIG. 3 above. Re-coiling may be advantageous for transport of the nickel plated copper. In some examples, re-coiling a copper coil at 108, may prepare the copper for shaping into components (e.g., stamping) in following steps. In other examples, re-coiling may not occur if the starting un-plated copper piece was a copper coil, depending on whether a configuration of a stamping unit, such as stamping unit 406 of FIG. 4, may receive a coiled or uncoiled copper coil.

Next, the method 100 proceeds to 110 where components are optionally stamped from the plated copper. If the starting copper material included pre-stamped CBHE component(s), method 100 may not include 110. However, if the starting copper material was a shape other than that of CBHE components (e.g., a coil and/or a blank), stamping may form a shape of CBHE components (e.g., stamped, nickel plated copper plates 206 of FIG. 2) from the unformed nickel plated copper (e.g. nickel plated copper blank 204 of FIG. 2 or re-coiled, nickel plated copper coil 308 of FIG. 3). CBHE components formed from stamping nickel or nickel alloy plated copper or copper alloy pieces may include coreplates, baseplates, heat transfer enhancement components such as fins and turbs, and the like. Stamping may include one or more steps to achieve a desired CBHE component shape and may involve one or more types of stamping, such as blanking, punching, piercing, bending, and the like. Stamping may be completed by a stamping unit of a continuous assembly line, such as stamping unit 406 of assembly line 400 shown in FIG. 4. There may be a single stamping unit as shown, or there may also be several stamping units in series and/or parallel. For example, there may be a stamping unit for each CBHE component shape.

Method 100 proceeds to 111 wherein stamped components, including pre-stamped components and/or components stamped at 110, are assembled. Assembling may include positioning and aligning components and/or fittings and/or filler metal pieces to their relative positions in a CBHE design. For example, filler metal shims may be placed between components where braze joints are to be formed. Assembling may not include attaching components together directly. As such, components may be held by a fixture until after brazing bonds components together. Assembling may take place as part of an assembly line such as after stamping unit 406 in assembly line 400 shown in FIG. 4. Alternatively, assembling may be part of a brazing unit such as brazing unit 408 in assembly line 400 of FIG. 4.

Following assembling, components are bonded together by brazing to form a CBHE at 112. For example, referring to FIG. 2, one or more stamped, nickel plated copper plates 206 may be layered with one or more other stamped, nickel plated copper components to form a brazed plate heat exchanger 208. Other embodiments of method 100 may include other types of CBHE components being brazed at 112, resulting in a desired heat exchanger assembly. Brazing may include applying high temperature by torch, furnace, induction, or other suitable methods of heating to nickel plated stamped CBHE components, and applying a filler metal to a desired joint area of heated components (e.g., stamped, nickel plated components). The filler metal may also be in the form of shims, wires, and/or pastes placed between components during and/or prior to heating. For example, shims may be placed between components during assembly at 111. The filler metal may be a metal or metal alloy with a lower melting point than that of copper and nickel, such as copper-phosphorus alloy, copper-phosphorus-silver alloy, and the like. The temperature may be less than a melting point of copper, and higher than a melting point of the filler metal. The filler metal may be positioned between the heated components such that the filler may cover and diffuse into two or more nickel or nickel alloy coatings to form a strong braze joint. The filler metal may also form an alloy with the nickel coatings in areas where filler is diffused into nickel coatings. For example, a copper alloy filler metal may form a copper-nickel alloy in a nickel coating. The formation of an alloy during brazing may be another distinguishing feature from post-braze plating identifiable through metallurgical examination, which will be discussed further below in regards to FIGS. 7A and 7B. Brazing may be completed as an automated and/or manual process in an assembly line, such as in brazing unit 408 of assembly line 400 in FIG. 4. After brazing at 112, a nickel plated CBHE (e.g., nickel plated CBHE 412 of FIG. 4) has been assembled from brazed, stamped, nickel plated components through method 100, thus method 100 ends. In some embodiments of method 100, brazing occurs only after plating. In other words, brazing may not occur before plating. In some embodiments, method 100 may include additional steps not shown, prior to 102 and/or following 112.

One embodiment of a CBHE resulting from method 100 may be brazed plate heat exchanger 600, shown in FIG. 6. Brazed plate heat exchanger 600 comprises a plurality of nickel plated components brazed together, including a plurality of plates 602 and inlet/outlet tubes 604. Braze joints, such as braze joint 500 of brazed plate heat exchanger 600, may exist at points of connection between two or more components in a CBHE formed by a pre-braze nickel plating method, such as method 100 of FIG. 1. CBHEs formed from brazed, stamped, nickel plated components by a pre-braze nickel plating method, such as method 100 of FIG. 1, may take a variety of forms, including a brazed plate heat exchanger, such as brazed plate heat exchanger 600, a shell and tube heat exchanger, and the like.

FIG. 5 shows an example of a braze joint 500 formed between two pre-braze plated and stamped components: first copper component 502 with first nickel coating 504 and second copper component 506 with second nickel coating 508. The coatings 504 and 508 may be in face sharing contact with copper components 502 and 506, respectively. The coatings 504 and 508 may cover an outer surface of copper components 502 and 506, respectively, and conform to the shapes of copper components 502 and 506, such that an even nickel coating is achieved on each component. A thickness 524 of first nickel coating 504 may be substantially the same over the surface of the first copper component 502. Similarly, a thickness 528 of second nickel coating 508 may be substantially the same over the surface of the second copper component, such that an even nickel coating is achieved. In some examples, thicknesses 524 and 528 of first nickel coating 504 and second nickel coating 508, respectively, may be within a range of 0.5 μm to 5 μm. In some examples, the thickness 524 of first nickel coating 504 may be the same as the thickness 528 of second nickel coating 508. In another example, the thickness 524 of first nickel coating 504 may not be the same as the thickness 528 of second nickel coating 508. A filler 510 diffuses into the nickel coatings, including first nickel coating 504 of first copper component 502 and second nickel coating 508 of second copper component 506. The filler 510 may be copper-phosphorus or copper-phosphorus-silver alloy, or another appropriate filler metal. The filler 510 may diffuse through the full thickness of one or more nickel coatings (e.g. thickness 524 of first nickel coating 504 and thickness 528 of second nickel coating 508) at one or more points such that filler may reach copper cores (e.g. first copper core 512 and second copper core 514). Additionally or alternatively, the filler 510 may diffuse partially though the thickness (e.g., thickness 524 and thickness 528) of the nickel coatings such that solid nickel exists between filler and copper within a component. In areas where filler 510 is diffused into first nickel coating 504 and second nickel coating 508, an alloy may be formed between the nickel and filler materials. For example, a copper-nickel alloy may be formed by a copper alloy filler diffusing into a nickel layer. In some examples, a filler may be diffused into two or more nickel coatings of two or more brazed, stamped, nickel plated components. The two or more brazed, stamped, nickel plated components may also be oriented in different ways relative to one another than as shown in braze joint 500 with similar diffusion of filler into corresponding nickel coatings. Brazed, stamped, nickel plated components may also be of different shapes than first copper component 502 and second copper component 506. Additionally, other relative proportions of copper, nickel, and filler metals than those shown in FIG. 5 may be used.

FIGS. 7A and 7B show example images 702, 704 from metallurgical examination of a post-braze plated CBHE and a pre-braze plated CBHE, respectively. Specifically, images 702, 704 show cross sectional views which may be compared to show differences in CBHEs formed from a post-braze plating method and a pre-braze plating method. For example, images similar to images 702, 704 may be taken by scanning electron microscopy (SEM) including X-ray dispersive energy spectroscopy (EDS), and the like in order to analyze surfaces of CBHEs and determine whether the CBHEs were plated with nickel pre-braze (e.g., through method 100 of FIG. 1) or post-braze. Image 702 shows a copper component 710 of a post-braze plated CBHE with a nickel coating 706, and a filler 708, wherein the filler 708 may be used in brazing to bond two or more copper components (e.g., copper component 710). Image 704 shows a copper component 720 of a pre-braze plated CBHE with a nickel coating 716 and filler 718, wherein the filler 718 may be used in brazing to bond two or more nickel plated copper components (e.g., copper component 720 with nickel coating 716). In both images, the filler 718 may be a copper alloy.

Pre-braze and post-braze plated CBHEs may be distinguishable by positioning of nickel and filler layers. For example, in the post-braze plated CBHE of image 702 in FIG. 7A, the filler metal is in face-sharing contact with the copper component 710, and the nickel layer 706 is in face sharing contact with filler 708. Additionally, the nickel coating 706 and copper component 710 are separated, at least in part, by the filler 708. In contrast, the pre-braze plated CBHE of image 704 in FIG. 7B shows the nickel coating 716 in face-sharing contact with the copper component 720. Therefore, positioning of filler metal layers and nickel coatings relative to copper components of a CBHE being analyzed may indicate the type of method (e.g., pre-braze or post-braze plating) used to form the CBHE.

Additionally, an identifiable element of pre-braze plating is alloy formation between the filler and nickel coating in a pre-braze plated CBHE, such as the pre-braze plated CBHE of image 704. To elaborate, during brazing (e.g., brazing at 112 of method 100 in FIG. 1), high temperatures may lead to diffusional movement of copper and nickel atoms toward each other from the filler 718 and nickel coating 716, respectively, thereby forming a copper-nickel alloy which may be tracked by elemental mapping (e.g., SEM, EDS). In 704, nickel coating 716 extends through the filler 718 to the surface 722 of the CBHE shown, therefore, an alloy may have been formed between the filler 718 and nickel coating 716. In contrast, a post-braze plated CBHE (e.g., the post-braze plated CBHE shown in image 702) does not have an alloy formed between filler 708 and nickel coating 706 because the nickel 706 is not present under high temperatures during brazing, and consequently, no diffusional movement occurs between atoms of the filler 708 and nickel coating 706. Thus, the heating during brazing that may cause alloy formation between filler metal and nickel coatings in a pre-braze plated CBHE does not cause alloy formation in a post-braze plated CBHE. In other examples, alloys may be formed between nickel coatings and other filler metals. In other words, alloy formation is not limited to copper-nickel alloys formed between a copper alloy filler metal and nickel coating, as described with the example shown in FIGS. 7A and 7B. In some examples, including the example given in FIG. 7A and 7B, element tracking showing formation of an alloy from diffusional movement of atoms in a coating and a filler of a CBHE may indicate that the CBHE was formed by a pre-braze plating method.

The technical effect of the method disclosed herein of creating nickel plated copper assemblies, such as CBHEs, with pre-braze nickel plating, and without brazing prior to nickel plating, is to reduce degradation of braze joints that occurs during pretreatment in a post-braze plating process, increase efficiency of the nickel plating process, and provide more even nickel plating coverage over surfaces of the CBHEs.

The disclosure also provides support for a method, comprising: pretreating a copper piece, electrolytically plating the copper piece with nickel to form a nickel plated copper piece, after electrolytically plating the copper piece with nickel, stamping components from the nickel plated copper piece to form stamped, nickel plated components, and brazing the stamped, nickel plated components. In a first example of the method, brazing occurs only after plating the copper piece with nickel. In a second example of the method, optionally including the first example, electrolytically plating the copper piece with nickel results in a nickel coating having a thickness in a range of 0.5 μm to 5 μm. In a third example of the method, optionally including one or both of the first and second examples, brazing includes applying a filler metal, and wherein the filler metal diffuses into two or more nickel coatings, forming an alloy of the filler metal and nickel coatings. In a fourth example of the method, optionally including one or more or each of the first through third examples, brazing forms a heat exchanger. In a fifth example of the method, optionally including one or more or each of the first through fourth examples, brazing is not completed before plating.

The disclosure also provides support for a method, comprising: electrolytically plating a copper or copper alloy piece with nickel or nickel alloy to form a nickel or nickel alloy plated copper or copper alloy piece, wherein electrolytic plating occurs before or after stamping the copper or copper alloy piece, brazing the nickel or nickel alloy plated copper or copper alloy piece, wherein brazing forms a heat exchanger. In a first example of the method, the copper or copper alloy piece is pretreated prior to electrolytically plating. In a second example of the method, optionally including the first example, stamping occurs after electrolytically plating and prior to brazing. In a third example of the method, optionally including one or both of the first and second examples, electrolytically plating results in a nickel coating having a thickness in a range of 0.5 μm to 5 μm. In a fourth example of the method, optionally including one or more or each of the first through third examples, brazing includes applying a filler metal, and wherein the filler metal diffuses into two or more nickel or nickel alloy coatings, forming an alloy of the filler metal and nickel or nickel alloy coatings. In a fifth example of the method, optionally including one or more or each of the first through fourth examples, the method further comprises: uncoiling the copper or copper alloy piece before plating. In a sixth example of the method, optionally including one or more or each of the first through fifth examples, brazing occurs only after plating. In a seventh example of the method, optionally including one or more or each of the first through sixth examples, brazing is not completed prior to plating.

The disclosure also provides support for a heat exchanger, comprising: a first copper component including a first nickel coating having a thickness in a range of 0.5 μm to 5 μm, a second copper component including a second nickel coating having a thickness in a range of 0.5 μm to 5 μm, a filler positioned between the first copper component and the second copper component, wherein the filler is diffused through the first nickel coating and the second nickel coating. In a first example of the system, the filler is a copper-phosphorus alloy or copper-phosphorus-silver alloy. In a second example of the system, optionally including the first example, the heat exchanger is formed by a method of pre-braze nickel plating. In a third example of the system, optionally including one or both of the first and second examples, the first copper component and the second copper component are stamped from nickel or nickel alloy plated copper or copper alloy. In a fourth example of the system, optionally including one or more or each of the first through third examples, an alloy is formed by the filler and one or more of the first nickel coating and the second nickel coating. In a fifth example of the system, optionally including one or more or each of the first through fourth examples, the first nickel coating is in face-sharing contact with the first copper component and the second nickel coating is in face-sharing contact with the second copper component.

In another representation, a method of forming a heat exchanger may comprise: pretreating a copper blank, electrolytically plating the copper blank with nickel to form a nickel plated copper blank, after electrolytically plating the copper blank with nickel, stamping components from the nickel plated copper blank to form stamped, nickel plated components, and brazing the stamped, nickel plated components to form brazed, stamped, nickel plated components. In a first example of the method, brazing occurs only after plating the copper blank with nickel. In a second example of the method, optionally including the first example, electrolytically plating the copper blank with nickel results in a nickel coating having a thickness in a range of 0.5 μm to 5 μm. In a third example of the method, optionally including one or both of the first and second examples, brazing includes applying a filler metal, and wherein the filler metal diffuses into two or more nickel coatings, forming an alloy of the filler metal and nickel coatings. In a fourth example of the method, optionally including one or more or each of the first through third examples, the method further comprises: forming a heat exchanger with the brazed, stamped, nickel plated components. In a fifth example of the method, optionally including one or more or each of the first through fourth examples, brazing is not completed before plating.

In another representation, a method of forming a heat exchanger may comprise: uncoiling a copper coil to form an uncoiled copper coil, electrolytically plating the uncoiled copper coil with nickel, and brazing components of the nickel plated copper coil. In a first example of the method, the copper coil is pretreated prior to electrolytically plating. In a second example of the method, optionally including the first example, the method further comprises: stamping the nickel plated copper coil, following electrolytically plating and prior to brazing. In a third example of the method, optionally including one or both of the first and second examples, electrolytically plating the copper coil with nickel results in a nickel coating having a thickness in a range of 0.5 μm to 5 μm. In a fourth example of the method, optionally including one or more or each of the first through third examples, brazing includes applying a filler metal, and wherein the filler metal diffuses into two or more nickel coatings, forming an alloy of the filler metal and nickel coatings. In a fifth example of the method, optionally including one or more or each of the first through fourth examples, brazing forms a heat exchanger. In a sixth example of the method, optionally including one or more or each of the first through fifth examples, brazing occurs only after plating. In a seventh example of the method, optionally including one or more or each of the first through sixth examples, brazing is not completed prior to plating. In an eighth example of the method, optionally including one or more of each of the first through seventh examples, the method further comprises: re-coiling the uncoiled, nickel plated copper coil following electrolytically plating.

In another representation, a heat exchanger may comprise: a first copper component including a first nickel coating having a thickness in a range of 0.5 μm to 5 μm, a second copper component including a second nickel coating having a thickness in a range of 0.5 μm to 5 μm, a filler positioned between the first copper component and the second copper component, wherein the filler is diffused through the first nickel coating and the second nickel coating. In a first example of the system, the filler is a copper-phosphorus alloy or copper-phosphorus-silver alloy. In a second example of the system, optionally including the first example, the heat exchanger is formed by a method of pre-braze nickel plating. In a third example of the system, optionally including one or both of the first and second examples, the first copper component and the second copper component are stamped from nickel plated copper. In a fourth example of the system, optionally including one or more or each of the first through third examples, an alloy is formed by the filler and one or more of the first nickel coating and the second nickel coating. In a fifth example of the system, optionally including one or more or each of the first through fourth examples, the first nickel coating is in face-sharing contact with the first copper component and the second nickel coating is in face-sharing contact with the second copper component.

In another representation, a method of forming a heat exchanger may comprise: pretreating one or more unformed copper pieces; electrolytically plating nickel onto the one or more copper pieces at a thickness in a range of 0.5 μm to 5 μm; stamping a first component of a heat exchanger and a second component of a heat exchanger from the one or more nickel coated copper; and brazing the first component of the heat exchanger to the second component of the heat exchanger.

FIGS. 5 and 6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
pretreating a copper piece;
electrolytically plating the copper piece with nickel to form a nickel plated copper piece;
after electrolytically plating the copper piece with nickel, stamping components from the nickel plated copper piece to form stamped, nickel plated components; and
brazing the stamped, nickel plated components.

2. The method of claim 1, wherein brazing occurs only after plating the copper piece with nickel.

3. The method of claim 1, wherein electrolytically plating the copper piece with nickel results in a nickel coating having a thickness in a range of 0.5 μm to 5 μm.

4. The method of claim 1, wherein brazing includes applying a filler metal, and wherein the filler metal diffuses into two or more nickel coatings, forming an alloy of the filler metal and nickel coatings.

5. The method of claim 1, wherein brazing forms a heat exchanger.

6. The method of claim 1, wherein brazing is not completed before plating.

7. A method, comprising:
electrolytically plating a copper or copper alloy piece with nickel or nickel alloy to form a nickel or nickel alloy plated copper or copper alloy piece, wherein electrolytic plating occurs before or after stamping the copper or copper alloy piece;
brazing the nickel or nickel alloy plated copper or copper alloy piece, wherein brazing forms a heat exchanger.

8. The method of claim 7, wherein the copper or copper alloy piece is pretreated prior to electrolytically plating.

9. The method of claim 7, wherein stamping occurs after electrolytically plating and prior to brazing.

10. The method of claim 7, wherein electrolytically plating results in a nickel coating having a thickness in a range of 0.5 μm to 5 μm.

11. The method of claim 7, wherein brazing includes applying a filler metal, and wherein the filler metal diffuses into two or more nickel or nickel alloy coatings, forming an alloy of the filler metal and nickel or nickel alloy coatings.

12. The method of claim 7, further comprising uncoiling the copper or copper alloy piece before plating.

13. The method of claim 7, wherein brazing occurs only after plating.

14. The method of claim 7, wherein brazing is not completed prior to plating.

15. A heat exchanger, comprising:
a first copper component including a first nickel coating having a thickness in a range of 0.5 μm to 5 μm;
a second copper component including a second nickel coating having a thickness in a range of 0.5 μm to 5 μm;
a filler positioned between the first copper component and the second copper component, wherein the filler is diffused through the first nickel coating and the second nickel coating.

16. The heat exchanger of claim 15, wherein the filler is a copper-phosphorus alloy or copper-phosphorus-silver alloy.

17. The heat exchanger of claim 15, wherein the heat exchanger is formed by a method of pre-braze nickel plating.

18. The heat exchanger of claim 15, wherein the first copper component and the second copper component are stamped from nickel or nickel alloy plated copper or copper alloy.

19. The heat exchanger of claim 15, wherein an alloy is formed by the filler and one or more of the first nickel coating and the second nickel coating.

20. The heat exchanger of claim 15, wherein the first nickel coating is in face-sharing contact with the first copper component and the second nickel coating is in face-sharing contact with the second copper component.
